(19) United States
(12) Patent Application Publication
(10) Pub. No.: US 2007/0136175 A1
(43) Pub. Date: Jun. 14, 2007

(54) On-line auction system and the method for the same

(75) Inventor: Seung June Song, SEOUL (KR)

Correspondence Address: BIRCH STEWART KOLASCH & BIRCH, PO BOX 747, FALLS CHURCH, VA, 22040-0747, US

(73) Assignee: Seung June SONG, SEOUL (KR)

(21) Appl. No.: 10/550,462

(22) PCT Filed: Mar. 25, 2004
(86) PCT No.: PCT/KR04/00679

§ 371 Date: Nov. 28, 2006

(30) Foreign Application Priority Data
Mar. 27, 2003 (KR) 10-2003-0019056

(51) Int. Cl. G06Q 40/00

(52) U.S. Cl. 705/37

(57) ABSTRACT

The present invention provides a method for on-line auction. According to the present invention including the steps of deciding whether there is an auction opened for a particular item, producing a new auction for the item if there is no auction opened for the item, withdrawing a present price inspection cash according to the request of a present price inspection by participants of the auction and decreasing the present price of the item by an amount of the withdrawn present price inspection cash, deciding a first bidder at the particular present price as a winner, determining the particular present price as a winning price, and closing the auction, and taking part in the new auction opened for other bidders after the first bidder's bidding and new participants.

### FIELD OF THE INVENTION

The present invention relates to an on-line auction system and the method for the same. Especially, the invention provides the on-line auction system and the method for the same in which price of selling item is continuously fallen down according to price-inspection of users, bid result on the item can be known without delay since the auction process progresses one by one selling unit of items and the users participated in the auction can purchase the item in order along their generosity to the item price since new auctions for the same item are continuously produced.

### BACKGROUND

Auction is a purchasing method in which several people compete to purchase some items.

In general on-line auction process, the auction host informs of the auction open time on which the auction is started. Seller offers initial price for their selling items and bidders offer money higher than the initial price. The bidders who offered the price in the high order within the number of selling items within the bidding period becomes winners and are awarded the item.

Accordingly, the opening of the auction is in unstable condition because the users of the on-line auction system can participate in the auction only if there is the opening information from the auction house. Also, the bidders who failed to be ranked in the highest order within the number of selling items cannot purchase the items.

However, people's need for the auction always exists. Accordingly, it is desirable if the auction is always open when the users need it. Further, the purchasable price varies by users. Accordingly, it is desirable if the various purchasable prices are reflected to the auction so that winning for the items happens at the various prices and a variety of bidders can obtain the items. Especially, it is desirable if the winning happen at the cheaper price than market price. Furthermore, it is desirable if the item price continuously falls down as the items are sold.

In the general on-line auction, the bid result is known after its bidding period. To correct this delay, instantaneous purchase is introduced in which the winning for the item is instantaneously informed if the bidder offers a particular price at which the seller readily wants to sell. However, the instantaneous purchase does not directly reflect the various purchasable prices. Accordingly, it is desirable if the bid result is known at the same time when the bid is made.

### SUMMARY OF THE INVENTION

The present invention satisfies the above-mentioned desires. The purpose of the present invention is to provide an on-line auction system and the method for the same where price of selling item is continuously fallen down, bid result on the item can be known without delay and the participants in the auction can purchase the item in order along their generosity to the item price. Additionally, the present invention provides the on-line auction system and the method for the same where the auction is always open when the users need it.

To accomplish the above-mentioned purpose, the present invention provides a method for on-line auction where a server computer for the auction is connected to a client computer via communication network by the relation of the server-client, the method comprising the steps of deciding whether there is an auction opened for a particular item; producing a new auction for the item if there is no auction opened for the item; withdrawing a present price inspection cash from a cash provider according to the request of a present price inspection by participants of the auction and decreasing the present price of the item by an amount of the withdrawn present price inspection cash; deciding a first bidder at the particular present price as a winner, determining the particular present price as a winning price, and closing the auction; and repeating the above steps for other bidders after the first bidder's bidding and new participants.

The method for on-line auction may further includes the steps of deciding whether there is a sponsor for the item being auctioned; deciding the sponsor as the cash provider if there is the sponsor and cash of the sponsor is larger than the present price inspection cash; and deciding the participant who requested the present price inspection as the cash provide if there is no sponsor or the cash of the sponsor is smaller than the present price inspection cash.

The method for on-line auction may further includes the steps of deciding whether there is any remained quantity for the item if there is no auction opened for the item; and closing the auction for the item if there is no remained quantity for the item.

The method for on-line auction may further including the steps of deciding whether there is a price discounted according to the remained quantity of the item; calculating the discount price if the discount is possible; and setting the initial price with discount price for the newly opened auction.

The method for on-line auction as recited in claim may further includes the steps of recording a reserved price and a reservation condition that the participant enters; deciding whether the auction which is progressing satisfies the reservation condition, comparing the reserved price with the present price if the auction progressing satisfies the reservation condition, determining the participant who made a reservation as a winner if the reserved price is higher than the present price and closing the corresponding auction.

In this case, if there a plurality of the reserved participants of the reserved participants, the comparison of the reserved price with the present price may be made between the reserved price made by the participant who reserved the highest price and bade the first and the present price.

The step of withdrawing a present price inspection cash from a cash provider according to the request of a present price inspection by participants of the auction and decreasing the present price of the item by an amount of the withdrawn present price inspection cash may include the step of deciding whether the participant of the auction opened is the loser of the prior auction and directly withdrawing the present price inspection cash if that is true.

The method for on-line auction may further includes the step of displaying the winner toward the winner and displaying the loser toward the bidders after the first bidder.

The method for on-line auction may further includes the steps of deciding whether the present price is below zero; determining the bidder who requests the present price inspection to make the present price below 0 as the winner.

The method for on-line auction may further includes the step of displaying the winning price history of the prior auctions towards the participants.

The method for on-line auction may further includes the step of displaying the change of the present price of the auction by the request of the participants.

The method for on-line auction may further includes the step of recording a portion of the present price inspection cash paid by the participants as the seller's profit.

Especially, the on-line auction can adopt a particular selling unit for the particular item.

The method for on-line auction may further includes the step of recording the decreased price portion by the present price inspections from the initial price as the seller's profit if the winner of the auction fails to make settlement of the item price.

The present invention provides an on-line auction system connected to client computers via communication network in relation of server-client, the system comprising a database server including a user database recording user information and user-cash in respect of each user, an item database recording item quantity, market price and present price-inspection cash necessary to inspect present price of the item in respect of each item and an auction database recording item to be auctioned, open and close (end) of an auction and winning price in respect of each established auction; and a process part processing the steps including deciding whether there is an auction opened for a particular item, producing a new auction for the item if there is no auction opened for the item, withdrawing a present price inspection cash from a cash provider according to the request of a present price inspection by participants of the auction and decreasing the present price of the item by an amount of the withdrawn present price inspection cash, deciding a first bidder at the particular present price as a winner, determining the particular present price as a winning price, and closing the auction, and repeating the above steps for other bidders after the first bidder's bidding and new participants.

In the on-line auction system, the auction system may be connected to a call center connected to user phones through telephone network, item information to be auctioned is displayed by the voice and the auction procedure processes by pressing the phone buttons.

The method for on-line auction may further includes the step of filling up the user cash by the payment of the real cash or other alternatives such as mileage or cyber money if the cash of the cash provider is smaller than the present price inspection cash.

In the method for on-line auction, the auction procedure may progress for the item, which a user of the client computer registers as a seller.

The method for on-line auction may further includes the step of displaying the present price inspection cash differently for the same item by setting the present price inspection cash differently.

The method for on-line auction may further includes the step of displaying item information to be auctioned grouping the different items having the same present price inspection cash.

The method for on-line auction may further includes the step of displaying item information to be auctioned by the items for which the sponsor pays the present price inspection cash.

The present invention provides a method for on-line auction where a server computer for the auction is connected to a client computer via communication network by the relation of the server-client, the method comprising the steps of displaying item information by ratio of present price inspection cash to initial price; choosing an item by a user of the client computers which the user wants to purchase; deciding whether there is an auction opened for the item; producing a new auction for the item if there is no auction opened for the item; withdrawing a present price inspection cash from a cash provider according to the request of a present price inspection by the user and decreasing the present price of the item by an amount of the withdrawn present price inspection cash; deciding whether the decreased present price is below zero and determining the bidder who requests the present price inspection to make the present price below 0 as the winner if the decreased price is below zero; repeating the above steps for other bidders after the winner and new participants.

The on-line auction method according to the present invention may be used as a price survey method wherein an appropriate price for an item is determined by averaging the winning price produced by the on-line auction method.

In the method for on-line auction according to the present invention, a reservation fee may be collected from the participants trying the reservation.

The method for on-line auction may further include the steps of holding a lottery for the participants and awarding free gift to the lottery-winner.

In the method for on-line auction, the step of displaying the change of the present price may be to display the change until the time when the participant inspect the present price.

### BRIEF EXPLANATION OF DRAWINGS

FIG. 1 is a view showing the configuration of the present invention;

FIG. 2 is a view showing the database tables according to the present invention;

FIG. 3 is a flow chart showing the process according to the present invention;

FIG. 4 is a flow chart showing the process if there is a sponsor;

FIG. 5 is a flow chart showing the process if there is a discount;

FIG. 6 is a flow chart showing the process if there is a reservation bidding;

FIG. 7 is a view showing an example of displays according to the present invention;

FIG. 8 is a view showing the conceptual feature of the present invention;

FIG. 9 is a view showing the general purchase pattern;

FIG. 10 is a view showing the feature of the present invention;

FIG. 11 is a view showing the general purchase pattern that the higher discount rate is applied as the purchasers increase; and

FIG. 12 is a view showing the effect that price is fallen down according to the present invention.

### DETAILED EXPLANATION OF PREFERRED EMBODIMENT

Now, the present invention will be explained with reference to the accompanying drawings.

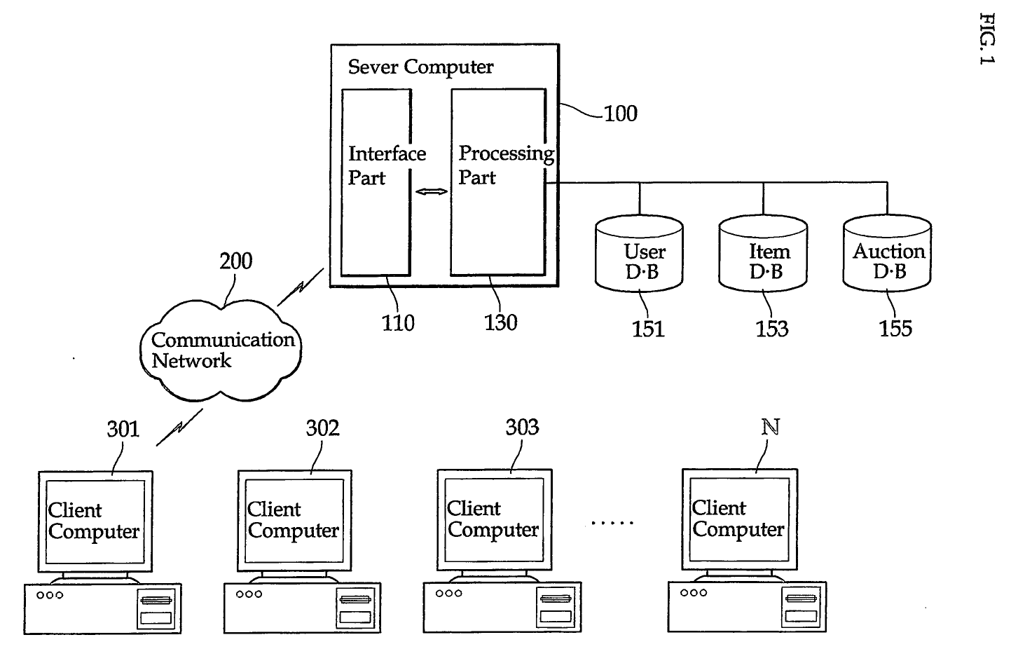

FIG. 1 shows the configuration of the on-line auction system according to the present invention.

Through communication network 200, a server computer 100 are connected with client computers 301, 302, 303, . . . , N. The client computers 301, 302, 303, . . . , N are computers which users participating in the auction operate and through which the users request or transfer data to the server computer 100.

The server computer 100 and client computer 301, 302, 303, . . . , N include CPU and memory. The CPU has a microprocessor and the memory includes ROM or RAM and stores a program deciding the operation of the CPU and data which the CPU processes.

The server computer 100 includes an interface part 110 for communication through the network 200. The server computer has a user database 151, item database 153 and an auction database 155 and the server computer 100 may additionally have a history database 161, a discount database 163, a sponsor database 165 and a reservation database 167. Furthermore, the server computer 100 includes a process part 130 for processing the following steps described later.

The client computers 301, 302, 303, . . . , N includes an interface part for network connection and a display part for displaying the information from the server computer 100. Especially, the client computers 301, 302, 303, . . . , N are not limited to personal computers (PC) and communication devices such as PDAs, mobile phones or digital television all which can communicate with the server computer 100 through the network 200 can be alternative.

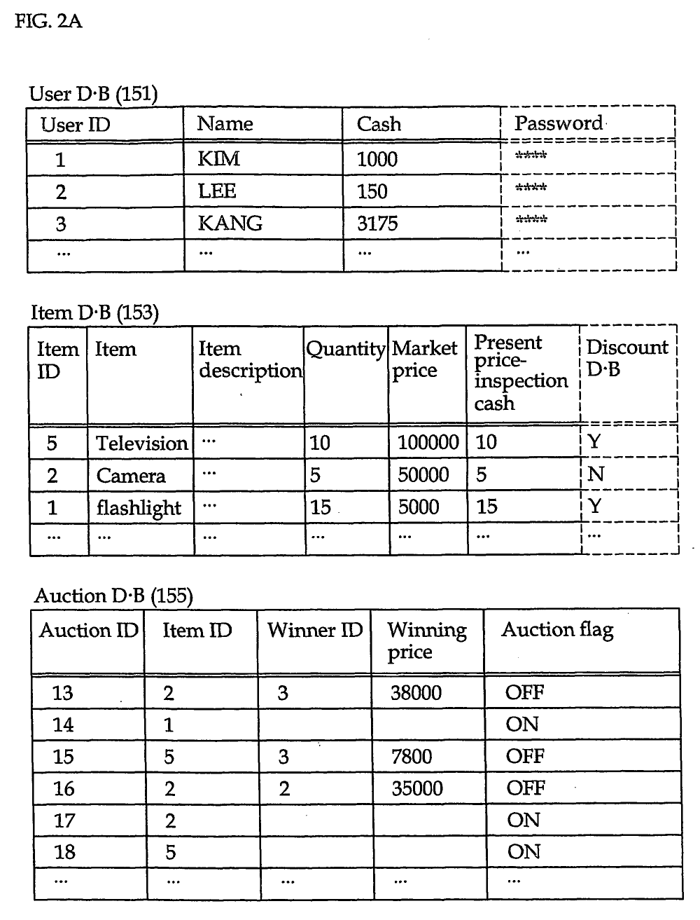

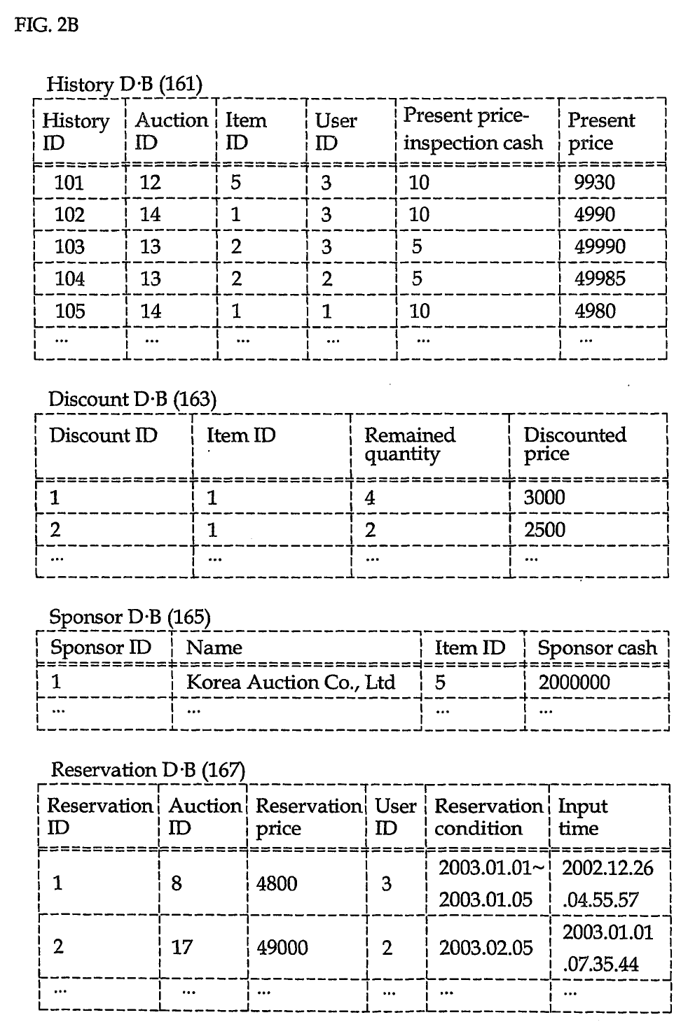

FIGS. 2a and 2b show database tables of the databases the server computer 100 has.

Firstly, the user database 151 records user information and user-cash in respect of each user. In this embodiment, as shown, user name and user-cash are recorded in respect of each user ID. The user database 151 may record password the user enters for the authentication.

The user-cash may be recorded, for instance, by the payment of real cash, by the mileage benefit or by the cyber-money through intermediation of other affiliated site.

The item database 153 records item quantity, market price and present price-inspection cash necessary for inspecting present price of the item as described later. In this embodiment, as shown, quantity, market price and price-inspection cash are recorded in respect of each item ID. If discount is made according to the remained quantity along the continuous production of new auctions for the same item, the item database 153 may record existence or non-existence of the discount database which records discount information.

The auction database 155 records item, open and close (end) of an auction and winning price in respect of each established auction. In this embodiment, as shown, item ID, the winning price and auction flag indicating that the auction progresses or ends are recorded in respect of the each auction ID. The flag record is ON when the corresponding auction is open and OFF when the corresponding auction is closed. When the auction is closed, the item-winner and the winning price are recorded.

When the user requests the present price inspection, the present price is fallen down as the auction process progresses. The history database 161 records the decreased (fallen) price in respect of the user who inspected the present price. In this embodiment, as shown, the auction ID, the user ID and the decreased present price are recorded in respect of each history ID.

The discount database 163 records discounted price according to the remained quantity. In this embodiment, as shown, the item ID and the discounted price according to the remained quantity are recorded in respect of each discount ID. Alternatively, discount rate may be recorded according to the remained quantity, or discounted price or discount rate may be recorded according to accumulated sold quantity.

Further, the server computer 100 may have the sponsor database 165 if there is a sponsor such as advertiser. In this case, the sponsor provides the price inspection cash and the price inspection cash is withdrawn (balanced) from the sponsor. Accordingly, the sponsor database 165 records the item ID and present cash of the sponsor in respect of each sponsor ID.

The reservation database 167 may be provided for, if the user reserves bidding by entering some reservation condition, determining the user who reserved the conditional bidding as the winner when the bidding condition is satisfied. In this embodiment, as shown, the reservation database 167 records the auction ID, reserved (bidding) price, the user ID, reservation condition and entering (input) time in respect of each reservation ID.

With reference to FIG. 3, the operation of the process part 130 of the on-line auction system 100 according to the present invention is explained.

Firstly, the client computers 301, 302, 303, . . . , N are connected to the server computer 100. (Step S301) At this stage, it is possible to do the user registration and performs the authentication if it is necessary.

When the users of the client computers 301, 302, 303, . . . , N access the server computer 100, the server computer 100 displays item information on the client computers 301, 302, 303, N. (Step S302) The item information includes a picture or image of the item, item description and unit of purchase. The item information may be provided in the form of movie, 3D or PDF files.

Then, the users operate the client computers 301, 302, 303, . . . , N to choose an item and the process part 130 recognizes it. (step S303) For instance, the click of the item image will makes the process part 130 to recognize the choice of the item.

Then, the process part 130 decides whether there is an already established auction in connection with the item. (Step S304). In this embodiment, the process part 130 searches auction the auction flag of which is ON in connection with the item ID.

If there is no established auction in connection with the item, new auction is established (opened). Otherwise, the user is took part in the readily established auction. At this stage, it may be necessary to decide whether there are remained quantity in connection with the item before new auction is created.

Therefore, the process part 130 decides whether there is the already established auction in connection with the item (Step S304) and opens the new auction (Step S306) after checking the remained quantity of the item (Step S305) if it fails to find the established auction. When opening the new auction (Step S306), the process part 130 subtracts item quantity to be auctioned from the item database 153 and records the result. If the process part 130 decides that there are no remained item quantity, end of the auction for the item is displayed and the auction is closed. (Step S307)

In case that there is the already opened auction in connection with the item, the user is directly took part in the opened auction and the control is directed to step S308.

In this embodiment, the open of the new auction is executed by producing new auction record on the auction database 155 and writing the auction flag ON.

Then, the process part 130 displays initial item price and present price inspection cash necessary to inspect the present price of the item in connection with the present auction on the client computers 301, 302, 303, . . . , N. The initial item price may be the market price on the item database 153. (Step S308) If the discount is made according to the remained quantity of the item (or the accumulated sold quantity of the item), the discounted price is displayed as the initial price as described later.

If the user wants to inspect the present price and requests it (Step S309), the corresponding present price inspection cash is withdrawn from cash provider and the item price is fallen down by the amount of the present price inspection cash. (Step S310) And the decreased price is displayed on the client computer of the user. (Step S311)

At this time, the present price inspection cash is withdrawn from the cash provider. The cash provider may be the user who requested the present price inspection of the item or the sponsor such as advertiser in connection with the item. If there is no sponsor, the present price inspection cash is withdrawn from the user database 151 and the result is recorded on the filed of the user cash. At this time, if the user cash is smaller than the present price inspection cash, it is possible to let the users fill up the user cash by the payment of the real cash or other alternative such as mileage or cyber money.

Further, in this embodiment, the decreased (fallen) present price may be recorded on the history database 161 and the user can inspect the present price recorded on the history database 161 as described later.

Then, the process part 130 of the server computer 100 decides whether there is a bid request at the present price. (step S312) And the process part 130 decides whether the bid request is the first. (step S313)

According to the present invention, the first bid requester is decided as the winner and the present auction is closed. (Step S314)

If the bid request in not the first, the user is decided as the loser and unsuccessful bid is displayed. (Step S315)

In this embodiment, the decision whether the bid request is the first is made by searching the auction flag in connection with the auction ID on the auction database 155. That is, when the auction flag is ON and there is the first bid request, the auction flag changes to OFF and the bid requester becomes the winner and recorded as the winner. Accordingly, if the auction flag is OFF when there is the bid request, it fails to be the first bid and the bid is unsuccessful. The corresponding auction is closed by changing the auction flag into OFF.

Then the loser of the auction is automatically took part in the new auction which is newly opened for the same item. Accordingly, the process of the process part 130 repeats from the step S304 after its notification of the unsuccessful bid.

For instance, the process part 130 decides the bid requester after the first bid requester as the loser and notifies it (Step S315). Then, the process part 130 decides whether there is the open auction for the same item. (step S304) If there is not a new choice of the same auction item (Step S303) and there are the remained quantity of the item, the new auction is open. (Step S306) The losers after the first loser are automatically took part in the auction which is already established by the first loser.

As described above, according to the present invention, the item price is continuously fallen down by the user's inspection of the present item price after the establishment of the auction for the item and the bid results are notified without delay since the first bid requester at the present price becomes the winner and the bid requester after the first becomes the loser. Further, the new auction is continuously produced for the losers of the former auction. Furthermore, the auction is always open and the auction is not in unstable condition.

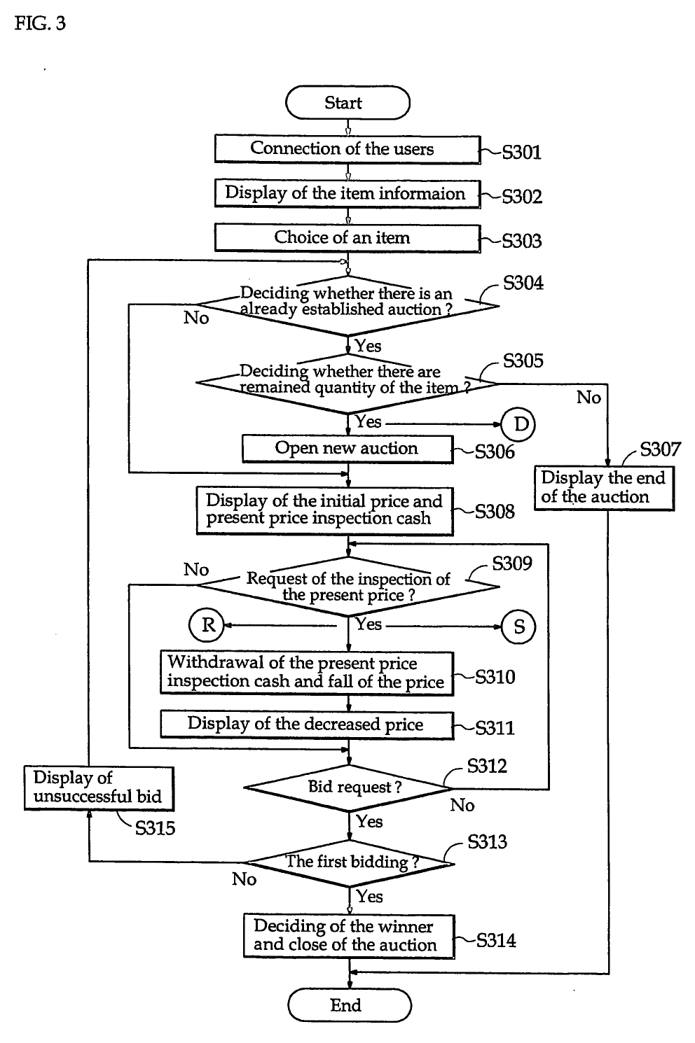

FIG. 4 shows the operation of the process part 130 if there is the sponsor.

Firstly, if there is the request of the present price inspection (Step S309 in FIG. 3), the process part 130 refers to the sponsor database 165 and decides whether there is the sponsor for the corresponding item. (Step S401) If there is the sponsor, it decides whether the sponsor cash is larger than the present price inspection price (Step S402) and withdraws from the sponsor the present price inspection cash and records the result. (Step S403)

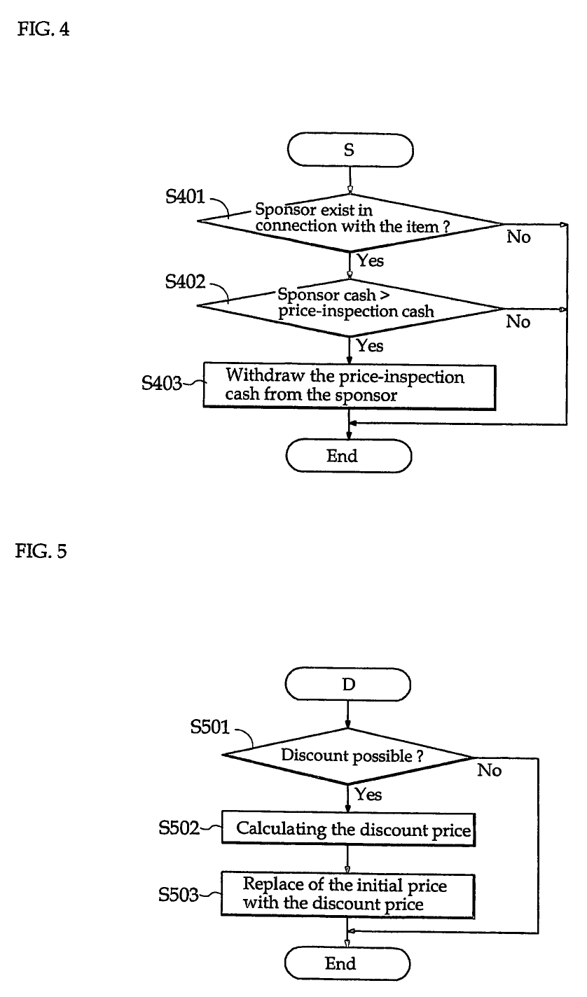

FIG. 5 shows the operation of the process part 130 if the initial price is discounted according to the remained quantity of the item.

Firstly, the process part 130 investigates the remained quantity of the item (Step S305 in FIG. 3) and decides whether there is discounted price according to the remained quantity of the item by referring to the discount database 163. (Step S501)

Then it calculates the discount price if the discount is possible. (Step S502) Then it replaces the initial price with the discount price. (Step S503) Accordingly, the initial price is displayed by the discount price.

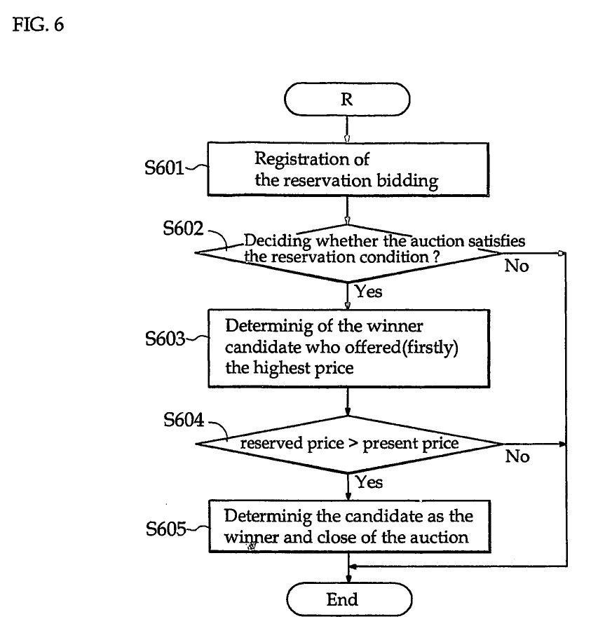

FIG. 6 shows the operation of the process part 130 of the server computer 100 if there is the reservation bidding.

In this case, the reservation bidding should be registered. That is, the users access the server computer 100 and enter the values on the reservation database 167. (Step S601)

In this circumstance, the process part 130 decides whether the auction satisfies the condition on the reservation database 167. (Step S602) For instance, if the reserved condition is directed to the particular auction item within particular period, it decides whether the auction which is now progressing satisfies the condition.

If the auction satisfies the reserved condition, the process part 130 determines the reserved bidder who offered the highest price as the winner candidate among the reserved bidders and, if there are plural reserved bidders who offered the same highest money, determines the reserved bidder who bade the first as the winner candidate. (Step S603)

Then, it compares the reserved bidding price of the winner candidate with the present price and judges whether the reserved bidding price is higher than the present price. (Step S604) Preferably, it compares the reserved bidding price plus the present price inspection cash with the present price of the present price inspection requester at present before subtracting the present price inspection cash. Because, in this case, the reserved bidder bade early at the same bidding price.

If the reserved bidding price is higher than the present price, the reserved bidder wins, the reserved bidder is recorded as the winner on the auction database 155, the relevant auction flag is changed to OFF and the corresponding auction is closed. (Step S605)

According to the present invention, when the prior auction bids are unsuccessful and the users are took part in the new auction, it is desirable for the users if the present price inspection price is automatically withdrawn without the request of the present price inspection. Because, in this case, the instantaneous price fall happens at the time when the losers of the former auction take part in the new auction. With reference to FIG. 3, if the auction is produced for the same item (Step S306), the process part 130 decides whether the user of the auction is the loser of the prior auction and instantaneously withdraws the present price inspection cash if the user is the loser. (Step S310)

It is possible for the present price to be fallen down below 0 (zero) as the present price is continuously decreased by the continuous present price inspection. In this case, the bidder who requests the present price inspection to make the present price below 0 is decided as the winner and the auction is closed and others becomes the loser. With reference to FIG. 3, if the present price is fallen down at step S310, the process part 130 decides whether the decreased price is below 0 and, if that is true, process goes to step 314 to decide the user as the winner and the corresponding auction is closed and other users of the losers are took part in the new auction.

In connection with this, it is possible to arrange the price inspection cash by rate to the initial price. For instance, if the present price inspection cash is arranged by 34% of the initial price, the present price inspection cash will be 3, 400 won if the initial price is 10,000 won. At this time, the aforementioned bidding procedure may be omitted. In this case, the winner of the auction is automatically decided. For instance, if the present price inspection cash is arranged by 34% of the initial price, the 3th requester of the present price inspection becomes the winner because the 3th request of the present price inspection makes the present price below 0.

According to the present invention, it is desirable to show the winning price history that is the records of the winning prices in prior auctions. By this, it is possible for the users to predict the price range between which the bid is successful.

Further, it is desirable to show the user who paid the present price inspection cash the continuous change of the present price until the time when the user paid the present price inspection cash. By this, the users can predict the following change of the present price. For this, in the present invention, if the user who paid the present price inspection cash requests to show the inspection history, the process part 130 of the server computer 100 sorts the present price along the time in connection with the corresponding auction on the history database 161 and displays them on the client computers 301, 302, 303, . . . , N. At this time, if the present price is further fallen down by the other user's present price inspection than the price when the user's present price inspection, it is desirable to notify the further falling of the present price.

According to the present invention, it is possible to notify the winners that the bids are successful when the winners are decided by means of the E-mail or SMS service. After that, if the winner settles the item price, the item is delivered. If there is a failure to the settlement of the item price, the selling of the item is treated as penalty and the decreased price portion by the present price inspections from the initial price is treated as the auction company's profit and recorded on the company profit database (not shown).

Especially, according to the present invention, the purchasing unit of the item is set differently and each of the auction can be processed in respect of the respective purchasing unit of item. For example, the purchasing unit of flashlight may be one or three and each auction can be progressed in respect of the each purchasing unit of one or three.

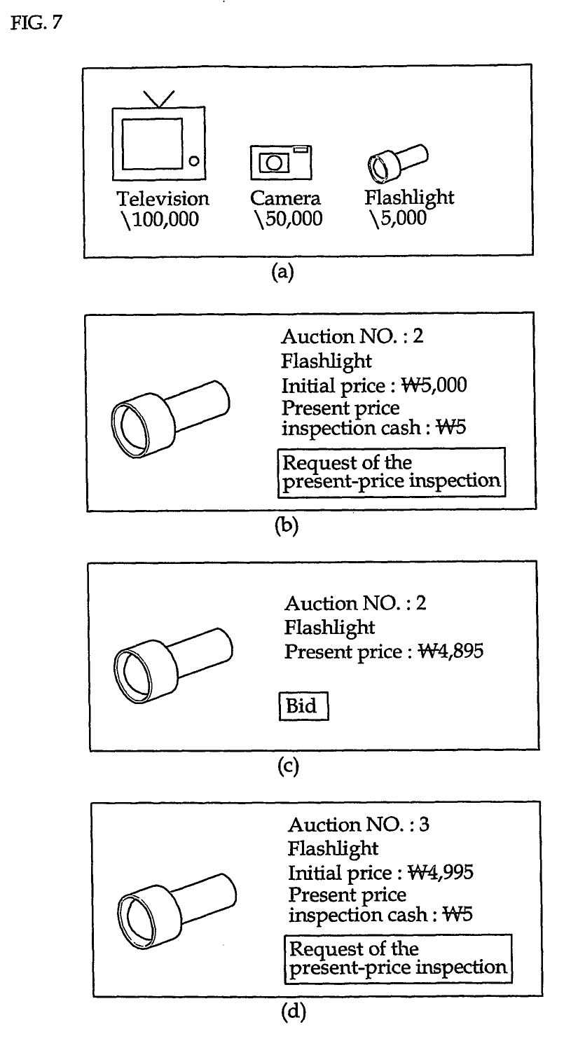

(a) to (d) in FIG. 7 shows example of display on client computers 301, 302, 303, . . . N.

Firstly, the item information is displayed as shown in FIG. 7(a),

When one of the items is chosen, the auction for the item is produced. For instance, when the flashlight is chosen, the display will be like as shown in FIG. 7(b). At this time, the initial price and the present price inspection cash are displayed and the auction number may be assigned and displayed. Further, a button for requesting the present price inspection is displayed.

When the users click the present price inspection button, the price is fallen down by the present price inspection cash and the decreased price is displayed as shown in FIG. 7(c). Also, a button for requesting the bidding is displayed. If the user clicks the bidding-request button, the bid at the displayed present price is requested.

If the bid is the first among the users, the first bidder becomes the winner and the successful bid may be displayed. However, if the bidding is made after the first bid, the relevant user becomes the loser and the unsuccessful bid may be displayed. Then the user is took part in the newly produced auction for the same item. FIG. 7(d) shows the loser's participation in the new auction in which the auction number is changed because the new auction is produced.

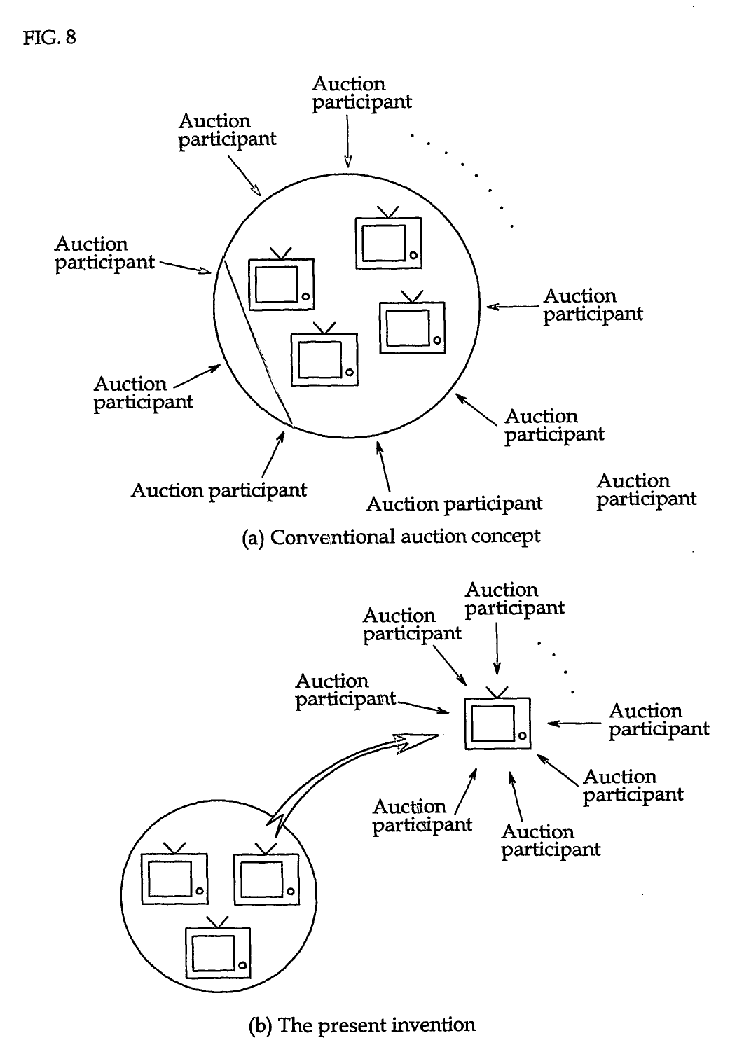

FIG. 8 shows the concept of the on-line auction according to the present invention.

According to the conventional on-line auction, one auction progresses by the selling quantity for the same item where a multiple of users take part in. Further, the conventional auction progresses within the period of time the auction company informed, the wining bids are determined in the high bidding price order within the number of selling quantity and the bid results cannot be known until the auction closing time.

However, according to the present invention, as shown in FIG. 8(b), the auction progresses by the respective product for the same item so that, for the same item, the new auction continuously progresses after the completion of one auction. The auction is always open and the auction is continuously open along the continuous decrease of the price so that the users can purchase the item in order along their generosity to the item price. Further, the bid results are known at the same time when bid is made.

According to the present invention, the present price inspection cash may be differently set for the same item and the item information may be displayed according to the different present price inspection cash. For instance, when the item information is displayed, the present price inspection cash is differently set by 5,000 won, 10,000 won or 2,000 won, each of which is displayed as the item information. The use can choose the affordable present price inspection cash and the other auction procedures progresses as described earlier.

Alternatively, the item information may be displayed by the different items having the same present price inspection cash. For instance, the same present price inspection cash is set for the refrigerator, television and camcorder and they are grouped to be displayed as the item information. The users choose the one group from the item information and the other auction procedures progresses as described earlier.

Furthermore, the item information may be displayed by the items for which the sponsor pays the present price inspection cash.

In the present invention, one user can upload the selling item and relevant information as the seller. For this, the server computer 100 includes a seller database and the item database records the seller's ID.

Especially, the present invention can be accomplished by means of ARS system. In this case, the server computer 100 is connected to the call center and the call center is connected to the user phone through the phone network. At this time, the item information display is made by the voice and the auction procedure processes by pressing the phone buttons.

According to the present invention, the successful bid price may be averaged and the averaged price is determined as the proper price.

When there is the reserved bidding according to the present invention, it is possible to collect reservation fee from the user trying to the reservation. Also, it is possible to collect the reservation fee differently according the reservation condition.

Furthermore, it is possible to hold a lottery for the users who did the item choice and award free gift to the lottery-winner.

### INDUSTRIAL APPLICABILITY

The market price always changes in the real world. The purchasers will buy the item at the present price which they know in order to obtain the item quickly or delay the purchase in order to search the price and obtain the item at a low price. It means that the price search needs cost (opportunity cost) such as time or money. FIG. 9 shows such a purchase pattern.

The item price may be accurate on the time when the price search is performed. However, it changes as time goes. Another price search also needs the cost such as time or money, but, it is not guaranteed that the price found by the secondary search is lower than that of the past and the price may rather be higher. It means that purchaser should purchase the item at the higher price in spite of the payment of the price search cost.

The opportunity cost the purchaser should pay for the price search assumes a variety of forms, for instance, such as traffic cost, communication cost or the time the purchaser has consumed.

The sellers also consume much cost for finding an appropriate market price. They are doing survey to find out the price at which consumers buy the item or request the price research to the agency.

As mentioned, although the purchasers and the sellers consumes the cost in order to find out the appropriate item price, the cost does not happen between the purchasers and the sellers and the common object of the purchasers and the sellers to decrease the price and the corresponding selling increase is not directly achieved between them.

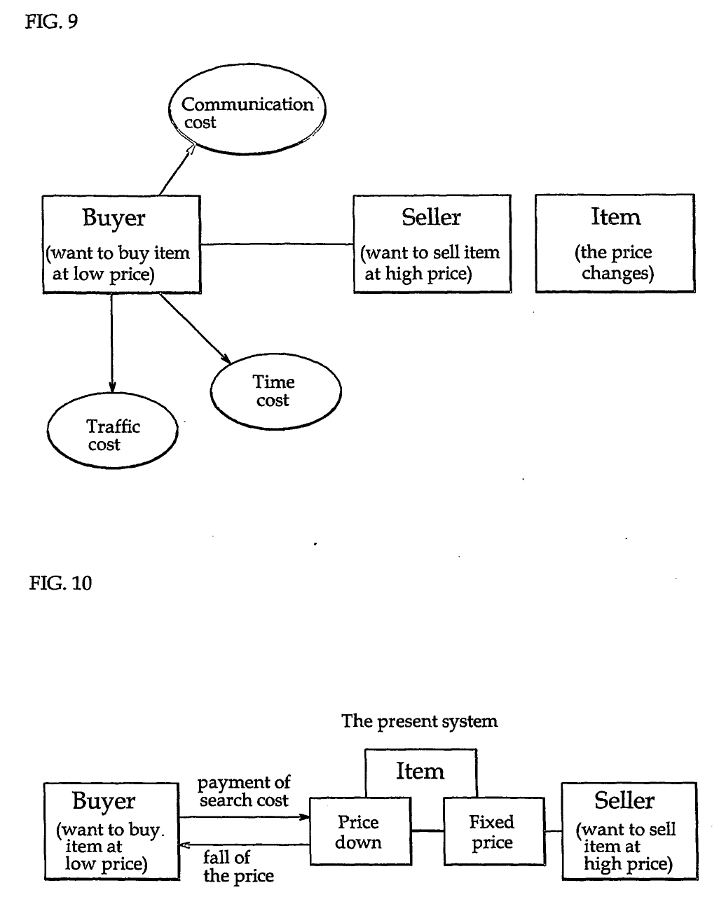

The on-line auction system and the method for the same according to the present invention configures what is called an on-line shopping mall targeting all the priced items and makes the purchasers pay the price search cost (the present price inspection cash), the price search cost assuming a variety of chooseable price, and makes them find out the present (decreased) item price. That is, the on-line shopping mall plays a role of price-researching agent the purchaser can cheaply and conveniently use. FIG. 10 shows this feature of the present invention.

According to the present invention, when the auction is started, the market price of the item is displayed. The purchases, who do not know the present selling price, will find the present price by paying the present price inspection cash. If the present price fails to satisfy the purchasers, the number of the price inspections are accumulated and the present price will be fallen down accordingly. This price inspection cash is definitely different from the bidding entry fee because the purchasers expense the price inspection cash in order to inspect the present price of the item.

In the on-line auction system and the method for the same, the decrease of the item price do not occur any problems on the seller side because the present price inspection cashes compensate for the decrease from the initial price. However, it is possible to offer the initial price by the lower price than the market price in order to induce the mass price inspection and selling.

Therefore, the present invention promotes the item trade by converting the price inspection cost, the purchasers and the sellers should pay in the real world, into the lowering the item price.

Further, the present invention may be added on the conventional on-line shopping mall. That is, whatever the online shopping mall as long as it notifies the item price can add on the present on-line auction system in which the item price will be the initial price from which the price will be down according to the price inspection. In this case, the on-line shopping mall may have an additional button on its interface, the click of the button leading to the present invention system.

There may be many purchase candidates when the first bidder (that is the winner) comes up as the item price is continuously fallen down according to the price inspection of the users and other users than the first bidder (that is the winner) will click the present price inspection button or bidding button without knowing the prior auction was closed. These bidding candidates (logically the loser of the prior auction) other than the first bidder will forms the early price inspector group in the next auction and, accordingly, the item price keeps the lower price. This flow repeats and it maximize the selling on the on-line shopping mall.

Further, since the new auction starts as soon as the bidding chance is closed, the users don't have to wait for new bidding chance, which result in higher selling of the item on the on-line shopping mall.

For instance, in the general common auction or the cooperative buying, if the number of the purchasers is larger than the number of the selling items, the discount of the selling price is possible. However, if the number of the purchasers is smaller than the number of the selling items, the intended aim to discount the price cannot be achieved.

For the explanation, let's assume the situation that there are 30 EA televisions, the model identifier of the television is KR-TV, and the television will be sold by 5EA, 10EA, 15EA and 20 EA, respectively. In the situation, the further discount rate will be applied as the selling unit increases. That is, as the selling unit is higher, the higher discount rate is applied and the price is decreased accordingly. In this case, a majority of the purchasers prefer the higher discount rate and, if the preferred discount is not satisfied, they will wait for further participation of other purchasers. As a result, it is difficult for the purchase to go smoothly.

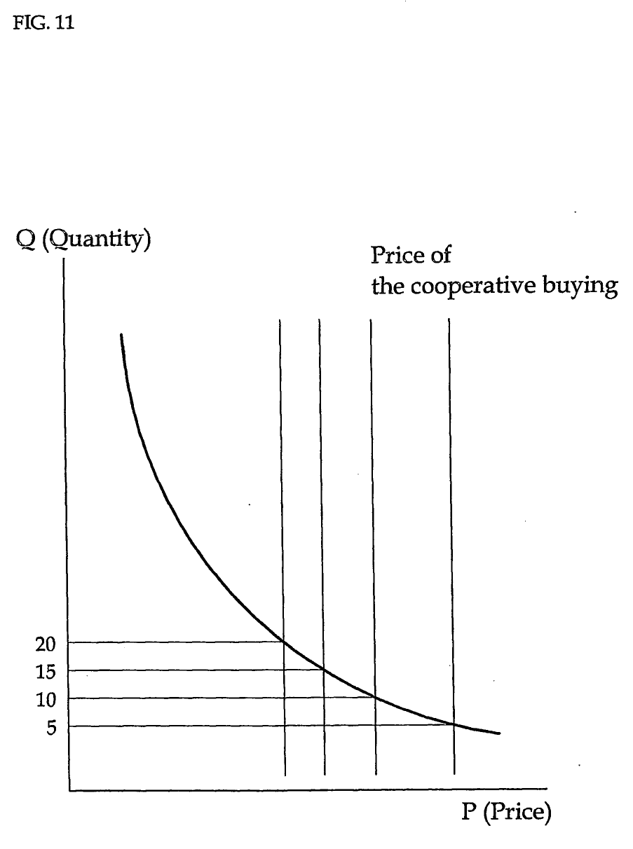

FIG. 11 shows the purchase pattern that the higher discount rate is applied as the purchasers increase.

The advantage of the present invention will be explained along the consumer's psychological trait with reference to the FIG. 11.

Let's assume that there are totally 20 positive purchasers and according to the discount rate based on the selling unit 5EA, 10EA, 15EA and 20EA, respectively, there are 4 positive purchasers, respectively. The positive purchasers are those who surely purchase the item if the price reaches the point they want. Also, there is 1 impulsive purchaser, respectively according to the discount rate based on the selling unit 5EA, 10EA, 15EA and 20EA, respectively.

According to the conventional cooperative buying, although 20 positive purchasers and 5 potential (impulsive) purchasers (totally 20 users) are accessed to the on-line shopping mall, the purchases may not happen because the market price at which even one user wants to buy is not formed. There needs 5 positive purchasers without the discount for the purchase to be made and the purchasers as well as the seller should wait a long time. Further, there is a possibility for the seller to lose the selling chance because the total 25 positive or impulsive purchase candidates connected to the on-line shopping mall may escape therefrom and may not come back to the on-line shopping mall again.

According to the present invention, the auction is established by 1 selling unit for the same item as shown in FIG. 8. For instance, if there are 30 EA televisions for the KR-TV model, the unique bidding number such as A01, A02, A03 . . . A30 are assigned to each item of the television, respectively and, when one bidding (A01) is completed, the next bidding (A02) is produced in sequence. Accordingly, there are 25 purchase candidates for the simple item of KR-TV1EA (unique bidding number is A01) and the price will be fallen down rapidly as the candidates inspect the present price. The price inspection cash is a part of the price search cost the purchaser should pay in the real world and converts into the discount of the price.

According to the present invention, the close time of the bidding chance is determined by the first bidder. Consequently, the bidding is made in sequence according to purchaser's generosity to the price from the most generous purchaser (who is willing to purchase at the highest price) among the 25 potential purchasers. As the purchasers repeatedly inspect the present price until the price reaches the point they want to buy, the first bidder comes up who becomes the winner. Then, new auction (for the bidding number of the item is A02) is open at once at which the other remained 24 purchasers will compete the price inspection.

Even if the discount is not applied to the new auction, the price will rapidly advance into the lower price than the initial price because the remained 24 purchasers who don't know the wining for the item A01 can know that the prior auction is closed only when they pay at least one inspection cost by inspecting the present price or requesting the bidding. In the end, before the last price inspector comes up, there is a high possibility that another bidding (that is the item purchase) is made.

Along this auction that the item price does not stay on the initial price, the stage reaches the next discount (5EA was sold) and, in the next new auction for the A06 item, the discounted price according to the accumulated selling items is notified. Since the discounted price according to the accumulated selling items (5EA) is accomplished, at this stage, the 4 positive purchasers and the 1 impulsive purchaser are willing to purchase the items, which leads to the next stage (10EA was sold) and leads to the next stage repeatedly.

Also, the bidders who fail to be the first bidder (logically the losers) at the prior auctions and continuously become the early price inspectors at the next auction may raise their preferred price as they pay the inspection cost repeatedly. This will contribute the formation of the market price.

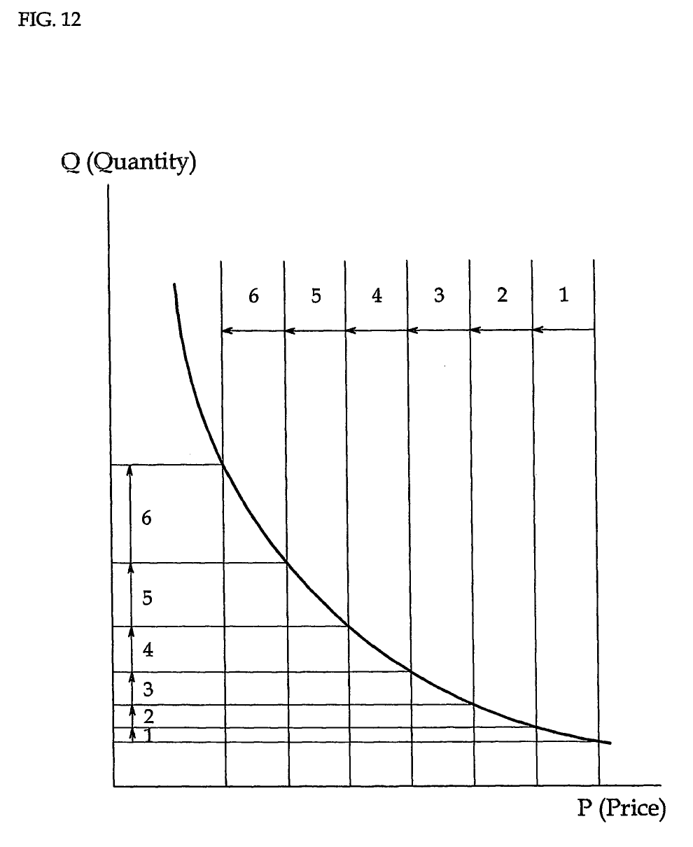

FIG. 12 shows the aforementioned feature of the present invention.

Additionally speaking, according to the cooperative buying or mass selling, the discount can be applied if the appropriate selling items are satisfied and the purchasers are negative to the buying before the certain number of the purchasers are secured. However, according to the present invention, since even when the one of the items are not sold, the price is continuously fallen down, sometime the price reaches point at which the purchasers want to buy. The purchasers will pay the price inspection cost since they have a need and curiosity to know the change of the price.

According to the present invention, the purchasers can have chances to buy the item at the discounted price again and again and the sellers can come up with the purchasers who are not expected by the conventional on-line auction. Therefore, the present invention is a WIN-WIN model for both of the purchasers and sellers.

The feature of the present invention can be summarized as follows.

First, the price search cost in the real world is converted into the falling of the price. Second, the selling and the selling quantity are promoted since the competition between the purchasers is excited by the assignment to each selling unit and the discount according to the selling.

Accordingly, the sellers can secure the appropriate margin and selling quantity, which guarantees the entire survival condition of a business, and the consumers can buy the item-goods by the lower price. Further, the information exchange between the purchasers and the stable service from the sellers are expected due to the mass selling according to the present invention.

Therefore, it is understood that the purpose of the present invention is accomplished. The present invention is described with reference to the specific embodiments, but the invention is not limited there to. Only the following claims will determine the scope of the invention.

What is claimed is:

1. A method for on-line auction where a server computer for the auction is connected to a client computer via communication network by the relation of the server-client, the method comprising:
(a) deciding whether there is an auction opened for a particular item;
(b) producing a new auction for the item if there is no auction opened for the item;
(c) withdrawing a present price inspection cash from a cash provider according to the request of a present price inspection by participants of the auction and decreasing the present price of the item by an amount of the withdrawn present price inspection cash;
(d) deciding a first bidder at the particular present price as a winner, determining the particular present price as a winning price, and closing the auction; and
(e) repeating the above steps for other bidders after the first bidder's bidding and new participants.

2. A method for on-line auction as recited in claim 1, further comprising:
(a) deciding whether there is a sponsor for the item being auctioned;
(b) deciding the sponsor as the cash provider if there is the sponsor and cash of the sponsor is larger than the present price inspection cash; and
(c) deciding the participant who requested the present price inspection as the cash provide if there is no sponsor or the cash of the sponsor is smaller than the present price inspection cash.

3. A method for on-line auction as recited in claim 1 or 2, further comprising:
(a) deciding whether there is any remained quantity for the item if there is no auction opened for the item; and
(b) closing the auction for the item if there is no remained quantity for the item.

4. A method for on-line auction as recited in claim 3, further comprising:
(a) deciding whether there is a price discounted according to the remained quantity of the item;
(b) calculating the discount price if the discount is possible; and
(c) setting the initial price with discount price for the newly opened auction.

5. A method for on-line auction as recited in claim 1, further comprising:
(a) recording a reserved price and a reservation condition that the participant enters;
(b) deciding whether the auction which is progressing satisfies the reservation condition, comparing the reserved price with the present price if the auction progressing satisfies the reservation condition, determining the participant who made a reservation as a winner if the reserved price is higher than the present price and closing the corresponding auction.

6. A method for on-line auction as recited in claim 5, wherein if there are a plurality of the reserved participants, the comparison of the reserved price with the present price is made between the reserved price made by the participant who reserved the highest price and bade the first and the present price.

7. A method for on-line auction as recited in claim 1, wherein the step (c) further include the step of deciding whether the participant of the auction opened is the loser of the prior auction and directly withdrawing the present price inspection cash if that is true.

8. A method for on-line auction as recited in claim 1, further comprising:
displaying the winner toward the winner and displaying the loser toward the bidders after the first bidder.

9. A method for on-line auction as recited in claim 1, further comprising:
(a) deciding whether the present price is below zero;
(b) determining the bidder who requests the present price inspection to make the present price below 0 as the winner.

10. A method for on-line auction as recited in claim 1, further comprising:
displaying the winning price history of the prior auctions towards the participants.

11. A method for on-line auction as recited in claim 1, further comprising:
displaying the change of the present price of the auction by the request of the participants.

12. A method for on-line auction as recited in claim 1, further comprising:
recording a portion of the present price inspection cash paid by the participants as the seller's profit.

13. A method for on-line auction as recited in claim 1 wherein the auctions are established by a particular selling unit for the particular item.

14. A method for on-line auction as recited in claim 1, further comprising:
recording the decreased price portion by the present price inspections from the initial price as the seller's profit if there is a failure to the settlement of the item price.

15. An on-line auction system connected to client computers via communication network in relation of server-client, the system comprising:
(a) a database server including a user database recording user information and user-cash in respect of each user, an item database recording item quantity, market price and present price-inspection cash necessary to inspect present price of the item in respect of each item and an auction database recording item to be auctioned, open and close (end) of an auction and winning price in respect of each established auction; and
(b) a process part processing the steps including deciding whether there is an auction opened for a particular item, producing a new auction for the item if there is no auction opened for the item, withdrawing a present price inspection cash from a cash provider according to the request of a present price inspection by participants of the auction and decreasing the present price of the item by an amount of the withdrawn present price inspection cash, deciding a first bidder at the particular present price as a winner, determining the particular present price as a winning price, and closing the auction, and repeating the above steps for other bidders after the first bidder's bidding and new participants.

16. A method for on-line auction as recited in claim 1, further comprising:
filling up the user cash by the payment of the real cash or other alternatives such as mileage or cyber money if the cash of the cash provider is smaller than the present price inspection cash.

17. A method for on-line auction as recited in claim 1 wherein the auction procedure progresses for the item which a user of the client computer registers as a seller.

18. A method for on-line auction as recited in claim 1, further comprising:
displaying the present price inspection cash differently for the same item by setting the present price inspection cash differently.

19. A method for on-line auction as recited in claim 1, further comprising:
displaying item information to be auctioned grouping the different items having the same present price inspection cash.

20. A method for on-line auction as recited in claim 1, further comprising:
displaying item information to be auctioned by the items for which the sponsor pays the present price inspection cash.

21. An on-line auction system as recited in claim 15 wherein the auction system is connected to a call center connected to user phones through telephone network, item information to be auctioned is displayed by the voice and the auction procedure processes by pressing the phone buttons.

22. A method for on-line auction where a server computer for the auction is connected to a client computer via communication network by the relation of the server-client, the method comprising:
(a) displaying item information by ratio of present price inspection cash to initial price;
(b) choosing an item by a user of the client computers which the user wants to purchase;
(c) deciding whether there is an auction opened for the item;
(d) producing a new auction for the item if there is no auction opened for the item;
(e) withdrawing a present price inspection cash from a cash provider according to the request of a present price inspection by the user and decreasing the present price of the item by an amount of the withdrawn present price inspection cash;
(d) deciding whether the decreased present price is below zero and determining the bidder who requests the present price inspection to make the present price below 0 as the winner if the decreased price is below zero;
(e) repeating the above steps for other bidders after the winner and new participants.

23. A price survey method wherein an appropriate price for an item is determined by averaging the winning price produced according to the on-line auction method in claim 1.

24. A method for on-line auction as recited in claim 5 wherein a reservation fee is collected from the participants trying the reservation.

25. A method for on-line auction as recited in claim 1 further comprising:
(a) holding a lottery for the participants; and
(b) awarding free gift to the lottery-winner.

26. A method for on-line auction as recited in claim 11 wherein the step of displaying the change of the present price is to display the change until the time when the participant inspect the present price.
